(19) United States
(12) Patent Application Publication
(10) Pub. No.: US 2008/0199000 A1
(43) Pub. Date: Aug. 21, 2008

(54) System and method for monitoring agents' performance in a call center

(75) Inventors: Yu Su, Shenzhen (CN); Yanyu Wu, Shenzhen (CN); Xiaojun Mo, Shenzhen (CN); Tao Sang, Shenzhen (CN); Hang Li, Shenzhen (CN)

Correspondence Address: Akin Gump Strauss Hauer & Feld LLP, P. O. Box 688, Dallas, TX, 75313-0688, US

(73) Assignee: Huawei Technologies Co., Ltd.

(21) Appl. No.: 11/708,766

(22) Filed: Feb. 21, 2007

(51) Int. Cl. H04M 3/00

(52) U.S. Cl. 379/265.06

(57) ABSTRACT

The present invention discloses a system and method for monitoring customer service agents' performance according to the interaction with one or more customers in a call center. The system comprises a call control server, a management console, and an agent console. The management console sends the call control server a first request, carrying a predetermined tag, to initiate a monitoring session, thereby triggering the call control server to send the agent console a second request, carrying the predetermined tag, to establish the monitoring session with the management console without notifying the agent, wherein during the monitoring session the agent console forwards a copy of data streams, related to the activities of the agent and one or more customer, to the management console.

### BACKGROUND

A call center helps an enterprise to integrate customer resources, customer services, marketing, and customer relations management. Moreover, a call center helps an enterprise to maintain an edge over its competitors by providing various customer related services in the highly competitive business environment. A well-operated call center increases the efficiency of a business operation, enhances customer relations, and boosts the market shares of the company.

Online monitoring is one of the essential functions of a call center. By means of online monitoring, the management observes how a customer service agent interfaces with customers and uses the information gathered from online monitoring for performance reviews.

Online monitoring can involve voice recording. A company could provide voice recording as a value-added service. In a call center, the management can choose to monitor and record customer service agents' performance. Online monitoring enables the management to evaluate the quality of services provided by its agents through voice recording. In a conventional call center equipped with narrowband communication equipment, monitoring and recording functions are performed by means of wire-tapping or multi-party conferencing.

As the telecommunications industry moves toward an Internet Protocol (IP) based communications system, there are necessary changes to the equipments used in a call center. Generally speaking, these changes include a new system for monitoring and recording conversations between customer service agents and customers in real time.

What is desired is an improved system and method for monitoring and recording customer service agents' performance in a call center equipped with broadband communication equipment.

### SUMMARY

The construction and method of operation of the invention, however, together with additional objects and advantages thereof, will be best understood from the following description of specific embodiments when read in connection with the accompanying drawings.

The present invention discloses a system and method for monitoring customer service agents' performance according to the interaction with one or more customers in a call center. The system comprises a call control server, a management console, and an agent console. The management console sends the call control server a first request, carrying a predetermined tag, to initiate a monitoring session, thereby triggering the call control server to send the agent console a second request, carrying the predetermined tag, to establish the monitoring session with the management console without notifying the agent, wherein during the monitoring session the agent console forwards a copy of data streams, related to the activities of the agent and one or more customer, to the management console.

### BRIEF DESCRIPTION OF THE DRAWING

The drawings accompanying and forming part of this specification are included to depict certain aspects of the invention. The invention may be better understood by reference to one or more of these drawings in combination with the description presented herein. It should be noted that the features illustrated in the drawings are not necessarily drawn to scale.

FIG. 1 (Prior Art) is a diagram illustrating a call center equipped with a narrowband communications system including a wire-tapping system.

FIG. 2 (Prior Art) is a diagram illustrating a call center equipped with a broadband communications system including a multi-line conferencing system.

FIG. 3 (Prior Art) is a diagram illustrating a call center equipped with a broadband communications system including an Ethernet switch with the port-mirroring function.

FIG. 4A is a diagram illustrating a call center equipped with a broadband communications system in accordance with one embodiment of the present invention.

FIG. 4B is a diagram illustrating a call center equipped with a broadband communications system in accordance with another embodiment of the present invention.

FIG. 5 is a flow diagram illustrating the process of setting up a recording session between an agent console and a management console based on the SIP protocol.

FIG. 6A is a diagram illustrating a call center 600 equipped with a broadband communications system in accordance with one embodiment of the present invention.

FIG. 6B is a diagram illustrating a call center 600 equipped with a broadband communications system in accordance with another embodiment of the present invention.

### DESCRIPTION

The following detailed description of the invention refers to the accompanying drawings. The description includes exemplary embodiments, not excluding other embodiments, and changes may be made to the embodiments described without departing from the spirit and scope of the invention. The following detailed description does not limit the invention. Instead, the scope of the invention is defined by the appended claims.

The system disclosed in the present invention provides monitoring and recording functions for a call center equipped with broadband communication equipment. The system provides a solution to the disadvantages of conventional systems identified in the background section.

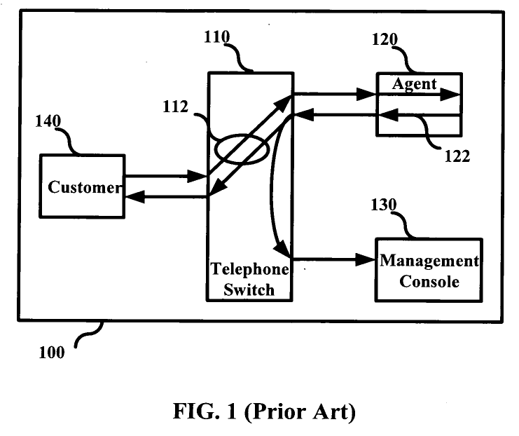

FIG. 1 is a diagram illustrating a call center equipped with a narrowband communications system including a wire-tapping system.

In a telephone switching system 110 used by the call center 100, the multiple time slots carrying a conversation between a customer service agent (agent) and a customer are switched by a telephone switching system 110. The telephone switching system 110 establishes a two-way voice channel 112 between an agent console 120 and a customer console 140. Multiple time slots are used to transmit and receive voice signals between the agent and the customer through predetermined transmitting and receiving time slots.

The agent console 120 functions as a regular telephone. The agent console 120 picks up the voice of an agent by the microphone and coverts the voice into voice signals, which are subsequently sent in the transmitting time slots. The agent console 120 also coverts a customer's voice signals received in the receiving timeslots into a voice, which is subsequently sent to an agent.

A management console 130 taps into the transmitting time slots of a customer service agent for monitoring the conversation between the agent and the customer. In order to wiretap, the customer's voice signal is fed into the agent's transmitting time slots 122. As a result, there might be echoes generated by the acoustics or the 2-wire to 4-wire-line conversion in the agent console.

The management console 130 receives a copy of voice signals carried in the transmitting time slots of the agent console. As a result, someone from the management, such as a manager or a team leader, can monitor the conversation between an agent and a customer. If a recording device is used, the conversation between an agent and a customer is recorded.

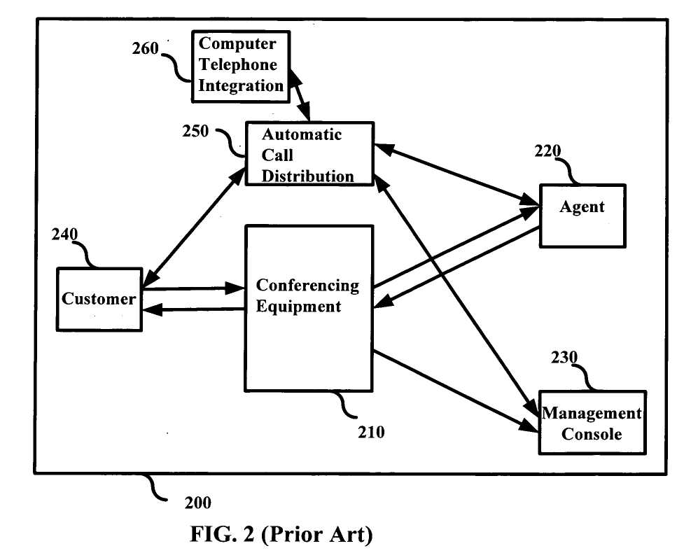

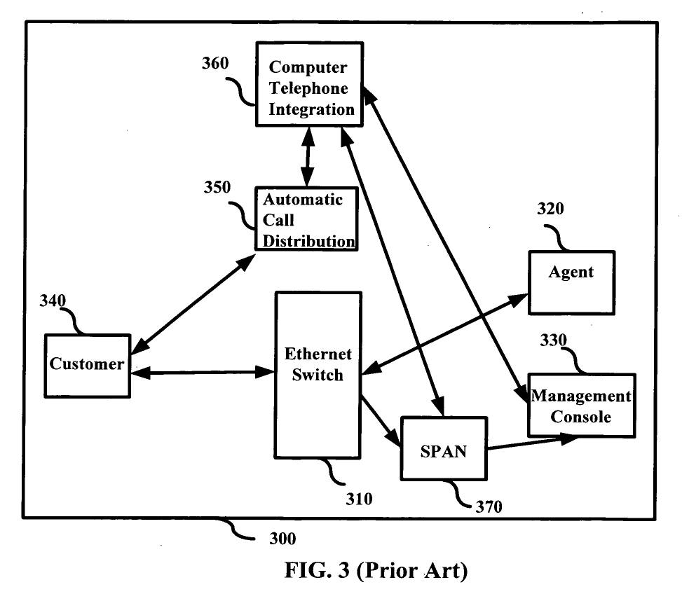

In a call center equipped with broadband communications equipment, the voice is converted into data steams and the IP protocol is used to exchange data streams. Therefore, a wire-tapping technique, shown in FIG. 1, cannot be used. Instead, multi-line conferencing, shown in FIG. 2, or the port-mirroring function of an Ethernet switch, shown in FIG. 3, is used to monitor and record the conversation between an agent and a customer.

FIG. 2 is a diagram illustrating a call center 200 equipped with a broadband communications system including a multi-line conferencing system 210. For example, the system includes a Soft Automatic Call Distribution (ACD) server 250 and a computer telephone integration (CTI) server 260. The Soft ACD server 250 and CTI server 260 together enables a computer to accept calls and to route them to appropriate terminals.

After a conferencing session is set up, an agent console 220, a management console 230, and a customer console 240 join a conference call via IP conferencing equipment 210. In other words, the three consoles are connected to the IP conferencing equipment via a broadband network.

The communication channel between the agent console 220 and the customer console 240 is bidirectional while that between the agent console 220 and the management console 230 is unidirectional. The IP conferencing equipment 210 forwards the data streams, exchanged between the agent and the customer, to the management console 230, thereby monitoring the conversation between the agent and the customer. If a recording device is used, the conversation is recorded.

A conventional conferencing system, such as the one shown in FIG. 2, has a number of disadvantages. Firstly, it is more costly due to the requirement of dedicated IP conferencing equipment. Secondly, in most cases, the conversation between an agent and a customer has already started when someone from the management initiates the monitoring of their conversation. The monitoring process tears down an existing communication session between an agent and a customer before it establishes a conferencing session for the agent, the customer, and the management. The interruption of an existing communication session results in an unpleasant experience for the customer. Lastly, all conversation sessions are routed through the IP conferencing equipment, which is not scalable to support a large amount of activities.

FIG. 3 is a diagram illustrating a call center 300 equipped with broadband communications system including an Ethernet switch 310 with the port-mirroring function.

The system includes a Soft Automatic Call Distribution (ACD) server 350 and a computer telephone integration (CTI) server 360. A communication session is established between an agent console 320 and a customer console 340 via an Ethernet switch 310. The agent console 320 and the customer console 340 are connected to the mirrored ports on the Ethernet switch 310.

A Switched Port Analyzer (SPAN) 370 is connected to a mirroring port on the Ethernet switch 310. The Ethernet switch forwards copies of data traffic between the agent console 320 and the customer console 340 from the mirrored ports to the mirroring port. The SPAN 370 analyzes the data collected from the mirroring port.

The SPAN 370 filters and processes the collected data traffic and separates the data streams between the agent and the customer from other data traffic. The data streams between the agent and the customer are forwarded to the management console 330, which subsequently monitors the conversation between the agent and the customer. The data streams between the agent and the customer can be saved to a file, and thus the conversation is recoded.

There are a number of disadvantages of the system, as shown in FIG. 3. Firstly, it requires a dedicated SPAN to filter and process the data collected from the mirrored port. Secondly, it requires an Ethernet switch that supports the mirroring function. Thirdly, to initiate the recoding function, the control port of the CTI server must be configured in such a way that it could analyze the data streams from/to a specific IP address.

Lastly, the SPAN must be configured directly or via the CTI server to forward the conversation between the agent and the customer to the management console. In general, a CTI server does not have information about the dynamic IP address assigned to an agent console. As a result, each agent console needs to be assigned a static IP address. The SPAN or the CTI server must be configured in such a way that the system retains the information about the IP address assigned to each agent console as well as the agents assigned to it.

Because the consoles of all agents must be connected to a centralized Ethernet switch, it is very difficult to support other types of consoles for agents and keep track of the assignment of consoles. The Ethernet switch becomes the bottleneck of the system because all the traffic is routed through it.

In summary, a conventional system for monitoring and recoding agents' performance has the following disadvantages. Firstly, a conventional system requires special equipment such as IP conferencing equipment, port-mirroring capable Ethernet switches, and SPANs. Secondly, whenever someone from the management initiates the monitoring function, the broadband communications system needs to tear down an existing communication session and establishes a new conferencing session. The monitoring process interrupts an established conversation session between an agent and a customer, which creates an unpleasant experience for the customer because both the agent and the customer are fully aware that they are being monitored. Thirdly, the CTI server or the SPAN needs to be configured directly in order to support the monitoring function. Lastly, each agent console needs to be assigned a static IP address and the system needs to retain the information about the IP address of each agent console as well as the agents assigned to it.

The present invention discloses a system and method for monitoring and recording customer service agents' performance in a call center equipped with broadband communication equipment.

To initiate a monitoring session, the management console establishes a connection with the agent console by issuing a session setup request command, which carries a predetermined tag, to a SoftCAD server. The predetermined tag, which is a text string representing the type of a call or the attribute of a call, indicates that a request for a monitoring session is issued. The agent console sets up a monitoring session accordingly.

A session setup request command can be sent based on the Session Initiation Protocol (SIP) or other interactive protocols such as H.323, MGCP, and H.248. The process of setting up a monitoring session should follow the specification of the protocol used in the system.

The agent console receives and recognizes the session setup request command, and a monitoring session for the management console is set up without being detected by the operating agent. The data streams between the agent console and the customer console are copied and forwarded to the management console.

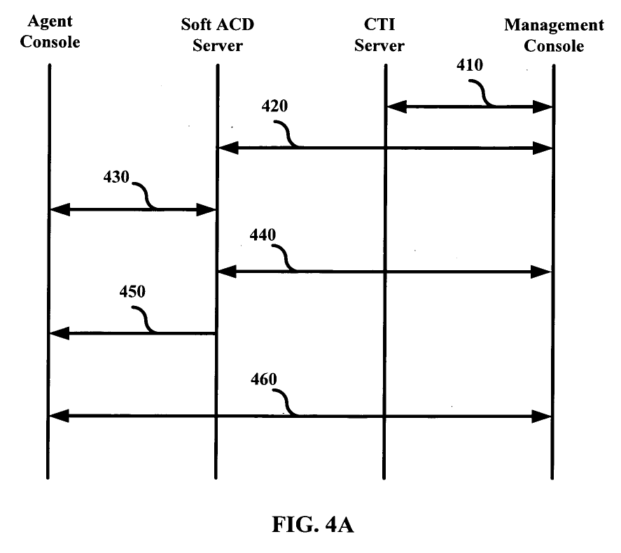

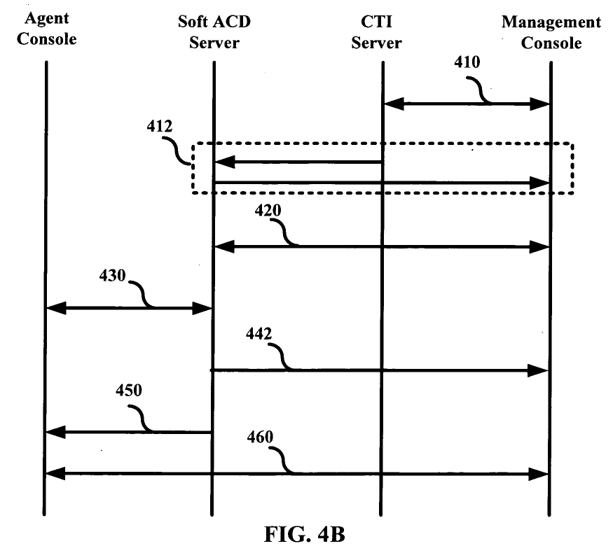

FIG. 4A is a diagram illustrating a call center equipped with a broadband communications system in accordance with one embodiment of the present invention. The process of setting up a monitoring session between an agent console and a management console is based on the SIP protocol.

In step 410, the management console sends the CTI server a request to set up a monitoring session. The request includes the information about the agent console that is being monitored. The CTI server looks up the uniform resource identifier (URI) of the agent console, and the information is returned to the management console.

In step 420, the management console sends a session setup request command to the Soft ACD server. The request carries a predetermined tag indicating that a request for a monitoring session is issued.

In step 430, the Soft ACD server sends a session setup request command to the agent console. The agent console receives and recognizes the session setup request command, and a monitoring session for the management console is set up without being detected by the operating agent.

In step 440, the Soft ACD server and the management console send each other an acknowledgement to acknowledge the completion of the session setup process.

In step 450, the Soft ACD server sends an acknowledgement to the agent console to complete the session setup process.

In step 460, the data streams carrying the conversation between the agent console and the customer console are copied and sent to the management console via a multimedia channel.

FIG. 4B is a diagram illustrating a call center equipped with a broadband communications system in accordance with another embodiment of the present invention. The process of setting up a monitoring session between an agent console and a management console is based on the SIP protocol.

Step 410 in FIG. 4B is the same as that in FIG. 4A. In step 412, the CTI server sends a monitoring request to the Soft ACD server, which in turn sends an INVITE message to the management console.

Steps 420 and 430 in FIG. 4B are the same as those in FIG. 4A. In step 442, the Soft ACD server sends an acknowledgement to the management console to complete the session setup process.

Steps 450 and 460 in FIG. 4B are the same as those in FIG. 4A. The data streams carrying the conversation between the agent console and the customer console are copied and sent to the management console via a multimedia channel.

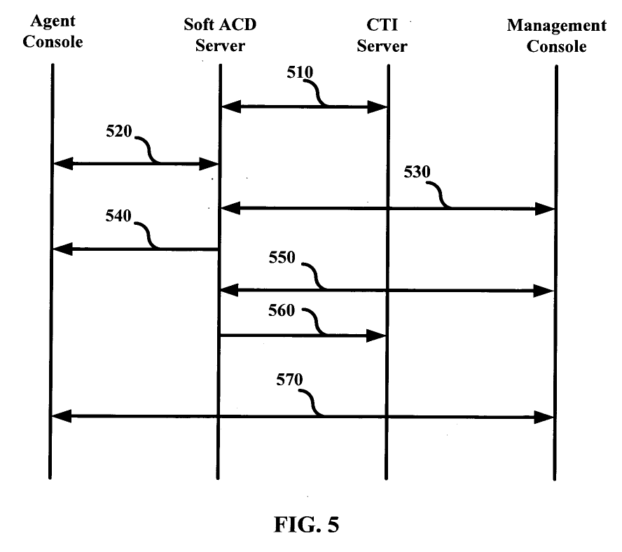

FIG. 5 is a flow diagram illustrating the process of setting up a recording session between an agent console and a management console based on the SIP protocol. The communication protocol between the recording server and the Soft ACD server is MGCP.

In step 510, the CTI server sends a start-recording request to the Soft ACD server. The request is triggered either by the request from a management console or from a predetermined configuration.

In step 520, the Soft ACD server sends a session setup request command to the agent console. The agent console receives and recognizes the session set up request command, and a monitoring session for the management console is set up without being detected by the operating agent.

In step 530, the Soft ACD server establishes a recording session with the recording server. The session setup messages are exchanged via CRCX interactive commands in the MGCP protocol.

In step 540, the Soft ACD server sends an acknowledgement to the agent console to complete the session setup process. In step 550, the Soft ACD server requests the recording server to start recording the conversation between the agent console and the customer console.

In step 560, the Soft ACD server sends an acknowledgement to the CTI server to complete the session setup process. In step 570, the data streams carrying the conversation between the agent console and the customer console are copied and sent to the recording server via a multimedia channel.

The following message is an example of an SIP INVITE command that carries a predetermined tag: INVITE sip:28780808@10.11.9.25:5060;type=monitor SIP/2.0. The parameter “type=monitor” carried in the message instructs the agent console to set up a monitoring session without informing the agent of the setup of the session.

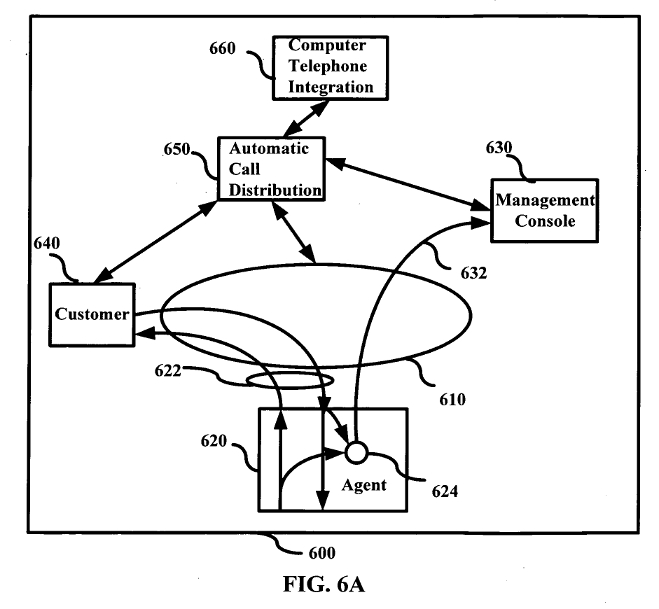

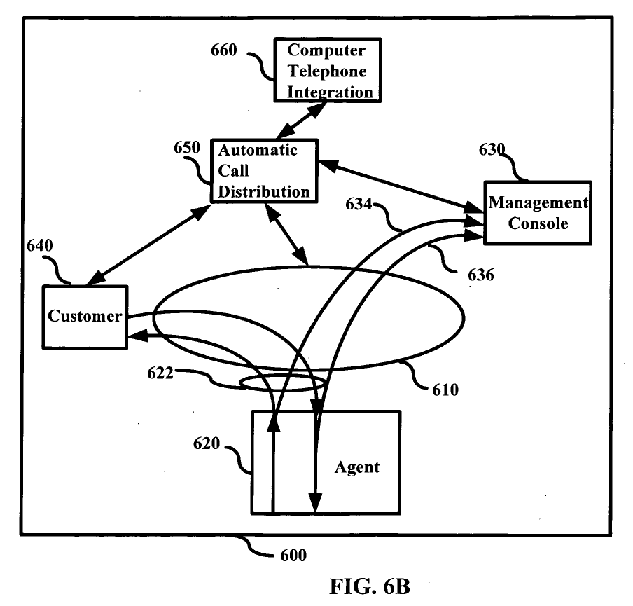

FIG. 6A is a diagram illustrating a call center 600 equipped with a broadband communications system in accordance with one embodiment of the present invention. The system includes a Soft ACD server 650 and a CTI server 660.

A communication session is established between an agent console 620 and a customer console 640 via an IP network 610, which provides a bidirectional communication channel 622.

The management console 630 sends the CTI server a session setup request command to register the request for a monitoring session. Once the request is granted, the management console 630 sends the Soft ACD server 650 a session setup request command with a predetermined tag to initiate a monitoring session.

After receiving the request, the Soft ACD server 650 sends the agent console 620 a session setup command to establish a monitoring session. The command sent by the Soft ACD server 650 carries a predetermined tag, indicating that a request for a monitoring session is issued.

The agent console 620 receives and recognizes the session setup command, and a monitoring session for the management console 630 is set up without being detected by the operating agent.

In the monitoring session, the agent console and the management console communicate via a unidirectional communication channel 632, from the agent console to the management console.

While the agent and the customer are engaged in their conversation, the agent console 620 combines the data streams from the agent with those from the customer console 640 at a mixer 624 before forwarding the combined data streams to the management console 630. By monitoring the combined data streams, someone from the management can evaluate the agent's performance. The same system can be used to record the communication session by simply routing the combined data streams to a recording device.

FIG. 6B is a diagram illustrating a call center 600 equipped with a broadband communications system in accordance with another embodiment of the present invention. The call centers shown in FIG. 6B and FIG. 6A have the same components, except for two. The agent console 620 does not have a mixer 624, and two unidirectional communication channels 634 and 636 replaces the unidirectional communication channel 632.

A communication session is established between an agent console 620 and a customer console 640 via an IP network 410, which provides a bidirectional communication channel 622. The management console 630 sends the Soft ACD server 650 a session setup command to initiate a monitoring session. After receiving the request, the Soft ACD server 650 sends a session setup command to the agent console 620 to establish a monitoring session. The command sent by the Soft ACD server 650 carries a predetermined tag indicating that a request for a monitoring session is issued.

The agent console 620 receives and recognizes the session setup command, and sends the data streams to the management console 630 via two unidirectional communication channels 634 and 636. The unidirectional communication channel 634 carries a copy of the data streams sent from the agent console to the customer console, and the unidirectional communication channel 636 carries a copy of the data streams sent from the customer console to the agent console. The management console 630 receives the data streams via the two unidirectional communication channels and monitors the conversation between the agent and the customer. The same system can be used to record the communication session by simply routing the data streams to a recording device.

The above illustration provides many different embodiments or embodiments for implementing different features of the invention. Specific embodiments of components and processes are described to help clarify the invention. These are, of course, merely embodiments and are not intended to limit the invention from that described in the claims

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A system for monitoring customer service agents' performance according to the interaction with one or more customers in a call center, the system comprising:
a call control server;
a management console; and
an agent console for sending data streams to one or more customers,
wherein the management console sends the call control server a first request, carrying a predetermined tag, to initiate a monitoring session, thereby triggering the call control server to send the agent console a second request, carrying the predetermined tag, to establish the monitoring session with the management console without notifying the agent, wherein during the monitoring session the agent console forwards a copy of data streams, related to the activities of the agent and one or more customers, to the management console.

2. The system of claim 1, wherein the agent console provides the management console with a copy of the data streams via a unidirectional channel during the monitoring session.

3. The system of claim 2, wherein the data streams from the agent console include those from a customer console used by the customer.

4. The system of claim 1, wherein the agent console provides the management console with a copy of the data streams from the agent console via a first unidirectional channel, and provides the management console with a copy of the data streams from a customer console used by the customer via a second unidirectional channel during the monitoring session.

5. A method for monitoring customer service agents' performance in a call center, the method comprising:
initiating a monitoring session by sending a first request from a management console to a call control server, wherein the first request carries a predetermined tag;
sending a second request to establish the monitoring session with the management console, wherein the second request is sent from the call control server to the agent console; and
establishing the monitoring session with the management console and forwarding a copy of data streams from the agent console, related to the activities of the agent and one or more customers, to the management console.

6. The method of claim 5, wherein the second request to initiate the monitoring session carrying the predetermined tag indicating that a request for a monitoring session is issued.

7. The method of claim 6, wherein the predetermined tag instructs the agent console to set up the monitoring session with the management console without notifying the agent.

8. The method of claim 5, wherein forwarding a copy of the data streams from the agent console to the management console is completed via a unidirectional channel during the monitoring session.

9. The method of claim 8, wherein the data streams from the agent console include those from a customer console used by the customer.

10. The method of claim 5, wherein forwarding a copy of the data streams from the agent console to the management console is completed via a first unidirectional channel and forwarding a copy of the data streams from the customer console used by the customer to the management console is completed via a second unidirectional channel during the monitoring session.

11. A method for monitoring customer service agents' performance in a call center, the method comprising:
initiating a monitoring session by sending a first request carrying a predetermined tag from a management console to a call control server, wherein the call control server includes an Automatic Call Distribution and a Computer Telephone Integration Server;
sending a second request to establish the monitoring session with the management console, wherein the second request, sent from the call control server to the agent console, carries a predetermined tag instructing the agent console to set up the monitoring session with the management console without notifying the agent; and
forwarding a copy of data streams from the agent console, related to the activities of the agent and one or more customers, to the management console.

12. The method of claim 11, wherein forwarding the data streams from the agent console to the management console is completed via a unidirectional channel during the monitoring session.

13. The method of claim 12, wherein the data streams from the agent console include those from a customer console used by the customer.

14. The method of claim 11, wherein forwarding a copy of the data streams from the agent console to the management console is completed via a first unidirectional channel and forwarding a copy of the data streams from the customer console used by the customer to the management console is completed via a second unidirectional channel during the monitoring session.
